(19) United States
(12) Patent Application Publication
(10) Pub. No.: US 2007/0237152 A1
(43) Pub. Date: Oct. 11, 2007

(54) Path Searching System Using Multiple Groups Of Cooperating Agents And Method Thereof

(75) Inventor: Chun Bao ZHU, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(73) Assignee: Nanyang Polytechnic

(21) Appl. No.: 11/762,742

(22) Filed: Jun. 13, 2007

(30) Foreign Application Priority Data
Jan. 20, 2003 (SG) 200300113-8

(51) Int. Cl. H04L 12/56

(52) U.S. Cl. 370/392; 706/13

(57) ABSTRACT

A path searching system (10) based on ACO with a graph generator (12), a path-searching engine (14), a storage medium (16), and a path optimizer (18). Output (20) of the system (10) is an optimal path containing a list of nodes and node links from a start node to a destination node. The graph generator (12) comprises a graph constructor (24), an editor (26), and a search definer (28) and couples to the storage medium (16) to generate a source graph. The path-searching engine (14) processes user inputs from a user input interface (22) that include information specifying a searching problem such as, for example, details of the start node, the destination node, and one or more optimization criteria for the optimal path. The source graph is constructed by the graph constructor (24) based on node/link data (30) and constraint information (32).

### FIELD OF THE INVENTION

The present invention relates to ant colony optimization techniques and path searching between a start point and a destination. In particular, this invention relates to a path searching system using multiple groups of cooperating agents and method thereof.

### BACKGROUND OF THE INVENTION

Searching for a path to meet one or more criteria is a common but difficult task in pickup & delivery services provided by organizations in industries such as, for example, tourism, transportation or logistics. In the art, path searching and tour routing are two basic versions of vehicle routing problems (VRPs).

In a typical situation for tour routing, a complete weighted graph G=(N,A,w) is provided, where N=(n₀, . . . , nₙ) is set of nodes, A={a(i,j): i≠j)} is the set of arcs, and each arc a(i,j) has an associated weight w_{i,j}>0, which, for example, represents the distance between nᵢ and nⱼ in a road map. This typical situation assumes that M vehicles are located at a single depot (a node in the graph) or multiple depots (multiple nodes in the graph). Other nodes in the graph are called customer nodes. The objective of tour routing is to find optimal routes with minimum cost or shortest total traveling length such that every customer node is visited only once by exactly one vehicle and each vehicle starts and ends at its depot.

Unlike tour routing, the objective of path searching is to find the shortest path from a start node to a destination in a source graph. A difference between tour routing and path searching is that, in tour routing, the number of nodes to be visited is known. On the other hand, in path searching, the number of nodes for an optimal path solution is not known, which makes it difficult for a path searching system to find a path solution in a map. Searching for the optimal path solution is therefore complex when the number of nodes in a connection network is large.

Most existing path searching systems require source graphs, such as Dijkstra's algorithm, to be provided in a tree-structure, which is a typical path selection algorithm. Other source graphs that are not in a tree-structure are complex networks that consist of a large number of nodes, which are completely or partially interconnected to each other.

In network communications, there are also routing techniques that resolve path routing problems to some extent. However, each of these routing techniques specifically resolve a particular situation for each of the path routing problems, and are therefore not suitable for path routing problems and, in particular, path searching based on a road map.

Genetic algorithms (GAs) provide another possible routing technique to obtain tour routing solutions when applied to, for example, the well-known traveling salesman problem. However, existing GAs are not able to provide solutions to path searching problems because the number of nodes in a path from a start node to a final destination is not known in path searching until a path solution is generated. In other words, it is not possible to apply GAs in path searching because the number of nodes is not known and cannot therefore provide a fixed length of chromosomes required by existing GAs.

Another approach to solve vehicle routing problems has been developed using what is known as ant colony optimization. M. Dorigo, and V. Maniezzo and A. Coloni initially deduced the ACO meta-heuristic in ant colony optimization by studying the behavior of real ants establishing the shortest path from their colony to feeding sources and back. The ACO meta-heuristic was then applied to solve various combinatorial optimization problems such as the traveling salesman problem and tour routing. In a related development, Bullnheimer, Hartl and Strauss developed an improved ant system for the vehicle routing problem.

Briefly, the ant colony optimization (ACO) algorithm is a meta-heuristic technique that makes use of simple cooperating agent called artificial ants. The ants iteratively construct candidate solution to a combinatorial optimization problem. An individual ant constructs a candidate solution by starting with an empty solution, and then iteratively adds solution components, which is selected using local search heuristic and pheromone deposited, if any, until a complete candidate solution is generated. After the solution construction is completed, the ants give feedback on the solutions they have constructed by depositing pheromone on possible paths using global pheromone updating rules. Solution components, which are better or partially better, are used by more ants, and therefore receive a higher amount of pheromone until an optimal solution is found.

The ACO meta-heuristic consists of three problem-solving steps. First, the optimization problem is defined into a graph. Second, a local searching heuristic is applied to select the next node for an ant to move to until the ant completes its solution construction. Finally, when all ants have constructed a complete solution, global pheromone updating rules are applied to update pheromone on links of visited nodes. Although the ACO meta-heuristic has been proven useful for solving different hard combinatorial optimization problems, it is not readily available for use to solve real-world combinatorial optimization problems as the problem definition, local searching heuristic and global pheromone updating rules are very much problem-dependent.

Furthermore, the ACO meta-heuristic has not been successfully used in path searching based on complex road maps. The reason why the ACO meta-heuristic has not been developed to solve path searching is because of the complexity and huge search space in a path search problem. For example, for a typical tour routing with forty nodes (N=40) to be visited, the search space is defined as N! (where N!=9.36×10³⁶). Thus, for a typical path search problem, a weighted graph can easily contain a few hundred or even thousands of nodes. The complexity level increases significantly when interconnection weights and constraints are further considered.

Therefore, what is needed is a path searching system and method using multiple groups of cooperating agents and based on the ACO meta-heuristic to search for an optimal path in a complex graph having a large number of interconnected nodes.

### SUMMARY OF THE INVENTION

The present invention seeks to provide a path searching system based on ant colony optimization (ACO), a method of determining an optimal path using the path searching system, and a product comprising computer usable medium having a computer program recorded thereon for determining the optimal path based on the method.

A path searching system based on ant colony optimization, the path searching system comprising:
at least one storage medium;
and
a path searching engine, coupled to the at least one storage medium, the path searching engine being adapted to perform path searching cycles on a source graph to thereby determine an optimal path between a start node and a destination node, the source graph having a plurality of node links and a plurality of nodes including the start node and the destination node, the path searching cycles being based upon local searching heuristic and global pheromone updating rules.

A method of path searching based on ant colony optimization, the method comprising:
constructing a source graph having a plurality of nodes, each of the plurality of nodes having at least one link to another node of the plurality of nodes;
initializing one or more searching parameters for one or more searching groups;
and
performing path searching cycles on the source graph for each of the one or more searching groups to determine an optimal path.

A product comprising computer usable medium having a computer program recorded thereon for path searching based on ant colony optimization, the product comprising:
computer program code means for constructing a source graph having a plurality of nodes, each of the plurality of nodes having at least one link to another node of the plurality of nodes;
computer program code means for initializing one or more searching parameters for one or more searching groups;
and
computer program code means for performing path searching cycles on the source graph for each of the one or more searching groups to determine an optimal path.

### BRIEF DESCRIPTION OF THE DRAWINGS

A preferred embodiment of the present invention is more fully described, by way of example, with reference to the drawings of which:

FIG. 1 is a functional block diagram of a path searching system based on ant colony optimization in accordance with the present invention;

FIG. 2 is an exemplary source graph constructed by a graph constructor of the path searching system of FIG. 1;

FIG. 3 illustrates definition of a node object and a node link object of the path searching system of FIG. 1;

FIG. 4 is an example of cooperating agent object of the path searching system of FIG. 1;

FIG. 5 illustrates a local searching heuristic used by cooperating agents to select the next node to visit in the path searching system of FIG. 1;

FIG. 6 illustrates global pheromone updating rules applied in the path searching system of FIG. 1;

FIG. 7 is a general flowchart of a method of path searching by the path searching system of FIG. 1 using multiple groups of cooperating agents;

FIG. 8a and FIG. 8b are detailed flowcharts of a path searching cycle within the method of FIG. 7; and

FIG. 9 is an example of a computer system for executing the method of FIG. 7 when stored in a product.

### DETAILED DESCRIPTION OF THE DRAWINGS

A path searching system based on ant colony optimization (ACO), a method of determining an optimal path using the path searching system, and a product comprising computer usable medium having a computer program recorded thereon for determining the optimal path based on the method are described in accordance with a preferred embodiment of the invention. In the following description, details are provided to describe the preferred embodiment. It shall be apparent to one skilled in the art, however, that the invention may be practiced without some of these details or without describing these details at length so as not to obscure the invention.

There are many advantages in applying the present invention. One advantage of the present invention is that determining an optimal path in a source graph having a large number of nodes that are interconnected by a large number of links is possible or at least easier than using existing path searching systems. Such a source graph represents, for example, a road map or a geographical map of a city. Consequently, the invention has an advantage over existing genetic algorithms (GAs) in that determining the optimal path is possible even though the number of nodes required for the optimal path is variable and not a fixed number.

Another advantage of the present invention is that the path searching system, the method, and the product improve on existing ACO meta-heuristic algorithms to enable path searching. This is because the path searching system, the method, and the product are not problem-dependent and can therefore be flexibly applied to different problems or situations encountered in path searching.

In describing the preferred embodiment, a geographical two-dimensional road map is used as an exemplary source graph in which nodes represent physical locations and roads represent links that interconnect the nodes. Physical location of a node is described by values of X and Y. Also, links can have specified weight factors such as road length and constrained parameters such as road conditions and speed limits. These specified weight factors and constrained parameters are used to evaluate one or more possible paths that are derived according to optimization criteria. It is to be noted that the invention may be applied to any environment, which can be virtually represented by a source graph and, therefore, the invention is not restricted to the exemplary source graph representing the geographical two-dimensional road map.

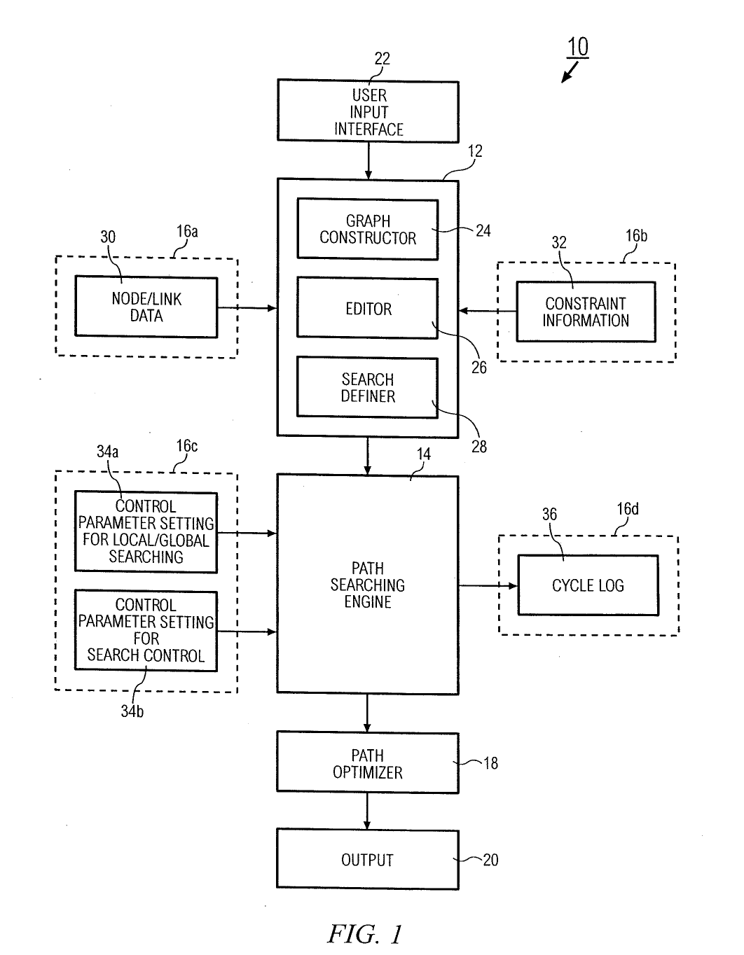

In accordance with the preferred embodiment of the present invention, a functional block diagram of a path searching system 10 based on ACO is illustrated in FIG. 1. The path searching system 10 comprises a graph generator 12, a path-searching engine 14, a storage medium 16, and a path optimizer 18. Output 20 of the path searching system 10 is an optimal path containing a list of nodes and node links from a start node to a destination node.

In determining the optimal path, the graph generator 12 is coupled to the storage medium 16 to generate a source graph. The storage medium 16 is divided into different parts (16a, 16b, 16c, 16d) according to data stored therein for illustrative purposes only. User inputs are provided via a user input interface 22 that couples to the graph generator 12. Such user inputs include information that specifies a searching problem such as, for example, details of the start node, the destination node, and one or more optimization criteria for the optimal path.

The graph generator 12 comprises a graph constructor 24, an editor 26, and a search definer 28. The source graph is constructed by the graph constructor 24 based on node/link data 30 associated with a plurality of nodes and a plurality of node links. Such node/link data 30 is stored in the storage medium 16a and includes node identification numbers, node names of the plurality of nodes, node linkages and link lengths of each of the plurality of node links. The storage medium 16b stores constraint information 32 that includes obstacle information.

The node/link data 30 and the constraint information 32 are editable by the editor 26 to reflect changing road conditions that may affect path searching. Data or information provided to the graph generator 12 is provided to the path-searching engine 14 to derive one or more possible paths between the start node and the destination node.

The path-searching engine 14 is an ACO-based search engine that processes user inputs and data associated with the plurality of nodes and the plurality of node links to thereby derive the possible paths from which the optimal path is then determined. Other requirements to derive the possible paths may include control parameter settings 34a,34b stored in the storage medium 16c. These control parameter settings 34a,34b are for local searching, global searching, and search control and include, for example, number of cooperating agents and number of path searching cycles.

Path searching cycles performed by the path-searching engine 14 are recorded and stored in the storage medium 16d as a cycle log 36. The cycle log 36 enables tracking of control parameter settings associated with the source graph or other source graphs that were constructed by the graph generator 12.

The possible paths derived by the path-searching engine 14 are provided to the path optimizer 18 to determine the optimal path between the start node and the destination node. The optimal path is then provided to the output 20, which may be a printer or a graphics display associated with a computer system (not shown).

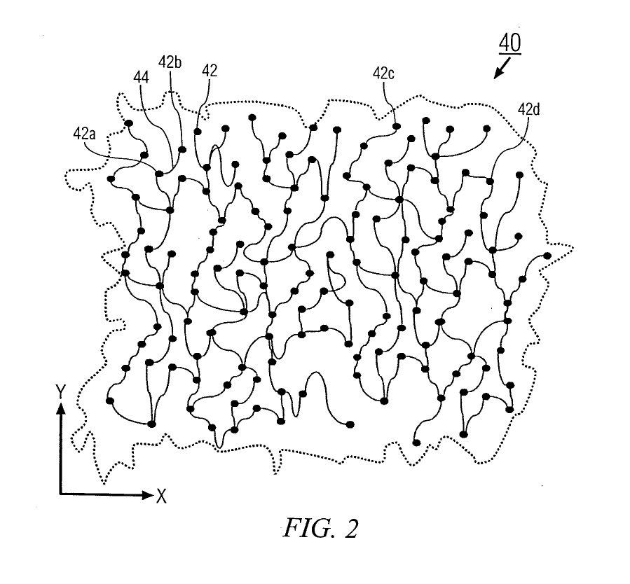

FIG. 2 is an exemplary source graph (G) 40 constructed by the graph constructor 24 of the path searching system 10. For this source graph 40,

G=(N, A, w),

where:

N=total nodes (geographic points) of the source graph 40;

A=total node links (arcs) of the source graph 40; and

w=weight.

As shown in the source graph 40, the N nodes are interconnected to each other by the A node links. A node 42 and a node link 44 are indicated in FIG. 2. The node link 44 is an arc between two nodes 42a,42b. Each node 42 may be linked to n other nodes 42, where n is greater or equal to one (n≧1). The N nodes 42 are classified into two categories: end nodes and intermediate nodes. An end node has only one node link or arc as indicated by, for example, node 42c. An intermediate node has two or more node links or arcs associated therewith as indicated by, for example, node 42d. In a search problem, the source graph 40 is similar to a road map.

Thus, for a kth-node (nₖ) with aₖ links, aₖ is a sub-set of the total links A (aₖ∈A ) and nₖ is a sub-set of the total nodes (nₖ∈N). For each node link (arcₖ) in aₖ, where arcₖ (i,j)∈aₖ:

weight wₗ_{_{—}}ₖ (i,j) is weight related to the distance from node i to node j; and

weight wₜ_{_{—}}ₖ (i,j) is weight related to the traveling time from node i to node j.

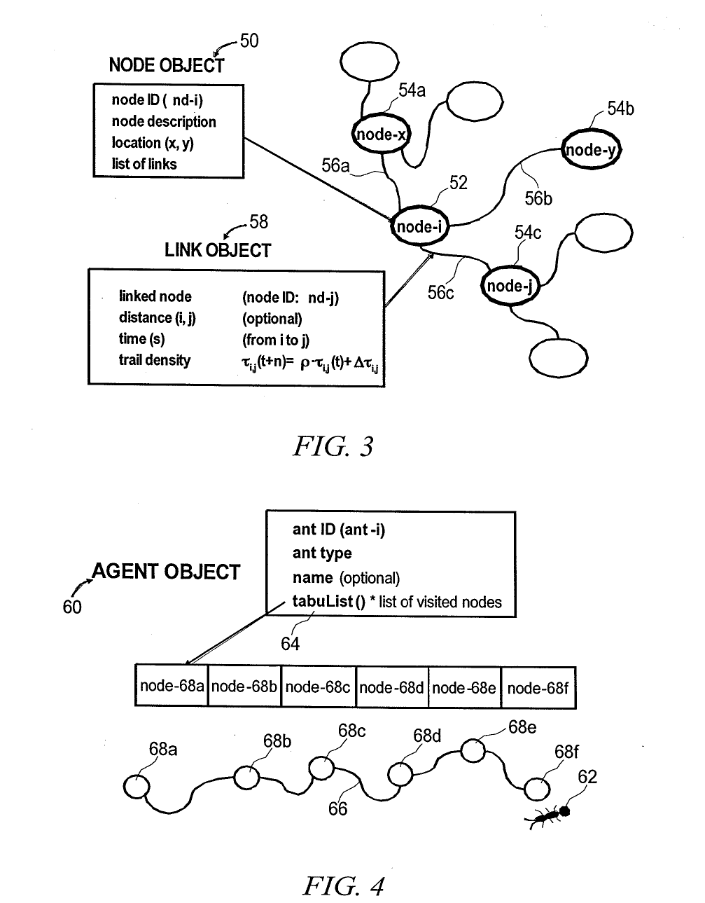

Referring now to FIG. 3, a node object 50 for a node 52, representing a typical node 42 of the source graph 40, contains information like node ID, node description, location (based on x,y coordinates in the graph) and a list of node links. The list of node links identifies embedded link objects that indicate how the node 52 is linked to one or more other nodes 54a,54b,54c via, respectively, three node links 56a,56b,56c.

Link objects, associated with node links 44, are not standalone objects but are embedded in association with node objects. For example, a link object 58 indicated in FIG. 3 and associated with the node object 50, contains node linkage information that includes a linked node identification, distance from the node 52 to the node 54c, traveling time from the node 52 to the node 54c, and trail density of the node link 56c. The node linkage information depends upon status of the node link 56c, such as road conditions of, or maximum speed allowed on the node link 56c. The trail density is modified by a cooperating agent according to evaluation results of a path searched by the cooperating agent using the global pheromone updating rules.

Referring now to FIG. 4, an agent object 60 that is associated with a cooperating agent 62 is shown. The agent object 60 identifies the cooperating agent 62 and has a list of visited node IDs referred to in this specification as a tabu list 64. The tabu list 64 is used to remember a traveled path 66 and serves as a memory for the cooperating agent 62. The list of visited node IDs contains information of visited nodes 68a,68b,68c,68d,68e,68f. For a k^{th}-Cooperating agent (agentₖ) the tabu list 64 is denoted as tabulistₖ.

Path searching by a cooperating agent in the invention starts from an initial node to a finishing node. The initial node may be either the start node or the destination node depending on a search direction taken by the cooperating agent. Likewise, the finishing node depends on the search direction and the initial node. Thus, if the initial node is the start node and the search direction is in a forward direction from the start node, then the finishing node can be either the destination node or an end node.

During a path searching cycle, the path searching system 10 adds nodes already visited to a tabu list and forbids the cooperating agent to visit any of these nodes again. This ensures that only valid paths are derived from the path searching cycle. The initial node is the first node in the tabu list. Thereafter, the cooperating agent continues to use local searching heuristic to search for another node to travel to until the finishing node is reached after a period of time, t. Depending on the initial node, the finishing node can be either the start node, the destination node or an end node. A tabu list that contains both the start node and the destination node is considered a possible path.

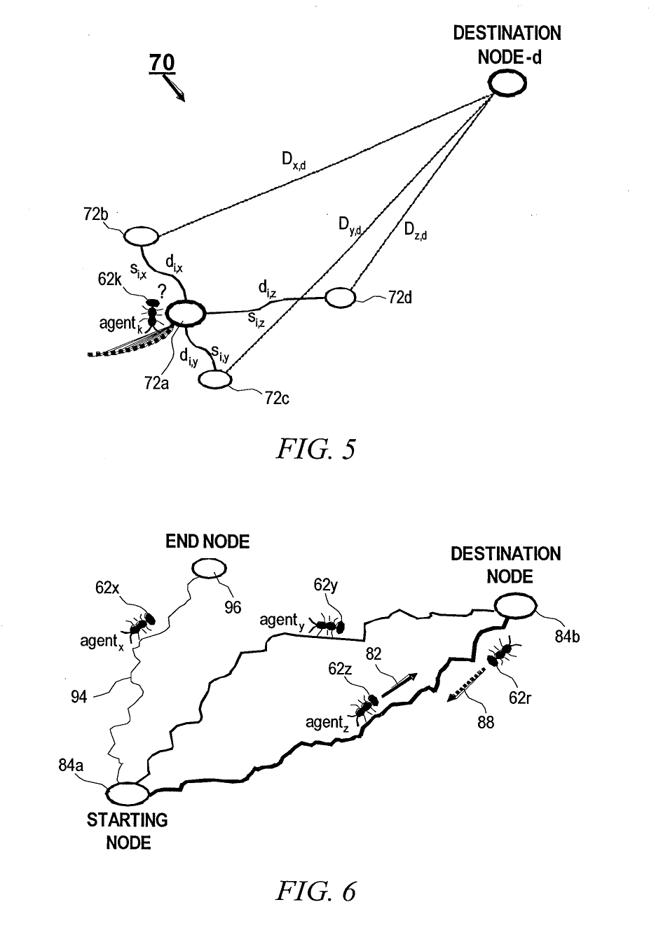

Referring now to FIG. 5, at time t, a cooperating agent 70 comes to a node 72a. Three other nodes 72b,72c,72d clinked to the node 72a. The cooperating agent chooses the next node to go to based on a probability function that depends on:
a) amount of trails present on a node link that is sometimes referred to as a connection edge;
b) distance of the next node from a current node (or maximum speed allowed if minimum traveling time is set as an optimization criterion); and
c) distance between a linked node (that is, a node linked to the current node) and the destination node.

The path searching system 10 uses a local searching heuristic to calculate a transition probability (P^{k}_{i,j}(t)) at time t from the current node to the next node for the cooperating agent. The transition probability is defined as follows:

$${p}_{i , j}^{k} = \{ \begin{matrix}\frac{{{{[ {τ}_{i , j} ( t ) ]}^{α} [ {μ}_{i , j} ( t ) ]}^{β} [ {ω}_{j , d} ( t ) ]}^{γ}}{{\sum }_{h ∈ {allowed}_{k}} {{{[ {τ}_{i , h} ( t ) ]}^{α} [ {μ}_{i , h} ( t ) ]}^{β} [ {ω}_{h , d} ( t ) ]}^{γ}} & j ∈ {allowed}_{k} \\ o & otherwise\end{matrix} \qquad ( 1 )$$

where: α=parameter to control influence of intensity of trail on path searching;
β=parameter to control influence of local desirability on path searching;
γ=parameter to control influence of global visibility (direction to destination node or start node).

In the transition probability defined in the above Equation (1), allowedₖ, is a set of nodes, which are linked to the current node at which a kth-cooperating agent (agentₖ) is located and η_{i,j} is local desirability. If the objective of the path searching is to search for the shortest path, η_{i,j}=1/d_{i,j}, then d_{i,j} is distance between node i and node j. If the objective is to minimize total traveling time, then η_{i,j}=1/t_{i,j}, (t_{i,j}=d_{i,j},/s_{i,j}), s_{i,j} is maximum speed allowed between node i and node j. For local searching, ω_{j,d} is global visibility (ω_{j,d}=1/D_{j,d}), D_{j.d} is distance from node j to the finishing node and τ_{i,j} (t) is the trail intensity on node link (i,j) at time t.

When all cooperating agents in a searching group have completed construction of their respective paths in one path searching cycle, the trail intensity τ_{i,j} (t) is updated using the following:
τ_{i,j}(t+n)=ρ·τ_{i,j}(t)+Δτ_{i,j} (2)
where, ρ is a coefficient such that (1−ρ) represents evaporation of trail between time t and t+n.

Δτi,j is calculated using the following:

$${Δτ}_{i , j} = {\sum }_{k = 1}^{m} {Δτ}_{i , j}^{k} \qquad ( 3 )$$

Δτ^{k}_{i,j} is quantity of trail substance per unit of length (pheromone in real ants) laid on node link (i,j) by the agentₖ between time t and t+n. It is given by:

$${Δτ}_{i , j}^{k} = \{ \begin{matrix}\frac{Q}{{Z}_{k}} & if link ( i , j ) ∈ valid path solutions \\ o & otherwise\end{matrix} \qquad ( 4 )$$

where, Q is a constant and Zₖ is path length travelled by the agentₖ if the shortest path is searched, or total time spent by the agentₖ on a searched path if minimum traveling time is required.

Unlike local searching heuristic in most of existing ACO meta-heuristic, path searching in the present invention considers not only the local desirability but also the global visibility. In other words, in the forward direction, the next node should generally be closer to the destination node rather than further away. Likewise, if the search direction is in a reverse direction starting from the destination node, the next node should generally be closer to the start node rather than further away.

In Equation (4), a valid path is such that the tabu list for a cooperating agent object has the initial node and the finishing node that are, respectively, the start node and the destination node in the forward direction or the destination node and the start node in the reverse direction. It is to be noted that not all tabu lists provide valid paths as a tabu list may have an end node as the finishing node.

In the application of the local searching heuristic defined by Equation (1), the cooperating agents in a searching group also considers global visibility, in addition to trail intensity and local desirability, to choose the next node to travel to. The values of α, β and γ in Equation (1) vary according to specification of the source graph. The cooperating agents being guided by the local searching heuristic are termed guided cooperating agents. Guided searching based on the local searching heuristic is efficient in the source graph when the nodes are well interconnected to each other. However, in a source graph with some end nodes located centrally, guided cooperating agents are more likely to be led to an end node rather than the start node or the destination node of a valid path.

To avoid likelihood of invalid paths arising from centrally located end nodes, the path searching system creates another type of cooperating agent referred to as free cooperating agents. A free cooperating agent is not strongly guided in that β and γ in Equation (1) are equal and set to zero or a number that is close to zero. Consequently, such free cooperating agents basically carry out random stochastic searching. It is to be noted that the free cooperating agents are not totally lost because they eventually follow paths with higher trail intensity as a result of other cooperating agents having reached the start node or the destination node.

Referring to FIG. 6, a cooperating agent 80 sets out on path searching in a forward direction 82 from a start node 84a to a destination node 84b. Another cooperating agent 86 sets out on path searching in a reverse direction 88. FIG. 6 also shows two other cooperating agents 90,92. The cooperating agent 90 is traveling on a path 94 between the starting node 84a and an end node 96.

In the present invention, the cooperating agents, such cooperating agents 80,86, are divided into four searching groups: a forward guided searching group, a forward free searching group, a reverse guided searching group, and a reverse free searching group. The forward guided searching group and the forward free searching group search for valid paths in the forward direction 82 from the start node 84a towards the destination node 84b. The reverse guided searching group and the reverse free searching group search for valid paths in the reverse direction 88 from the destination node 84b towards the start node 84a. An optimal path is determined based on four valid paths with each of these four valid paths being derived from each of the four searching groups.

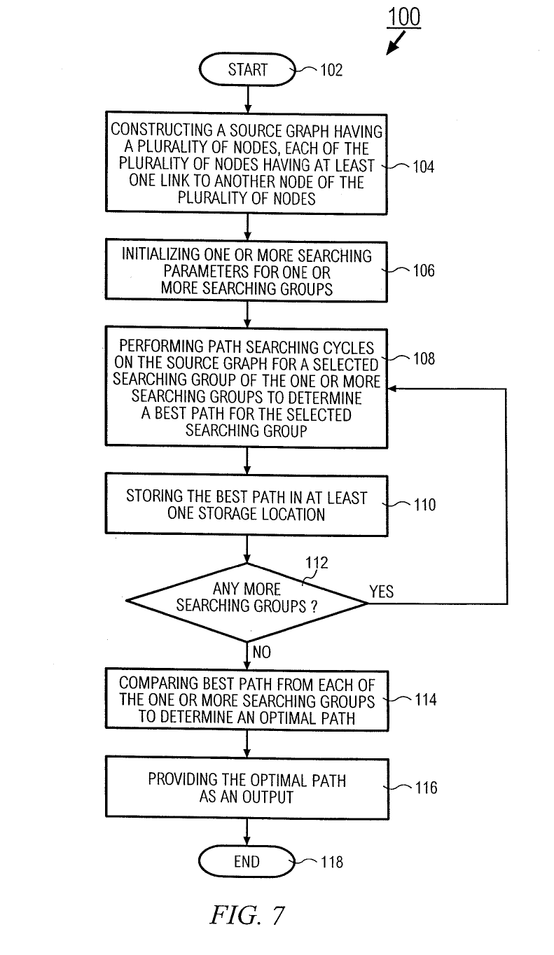

Referring now to FIG. 7, a general flowchart of a method 100 of path searching by the path searching system 10 based on ant colony optimization. In particular, the method 100 is described using multiple groups of cooperating agents. The method 100 starts with step 102 and proceeds to step 104 where a source graph is constructed.

Referring to FIG.7 and in step 104, the graph generator 12 retrieves data associated with the plurality of nodes and the plurality of node links from the storage medium 16a. Each of the plurality of nodes has at least one link to another node. Then the path searching system of the present invention identifies a start node, a destination node and a searching objective based on user input received from the user input interface 22. The searching objective is to search for a path with the shortest traveling distance or shortest traveling time, which is constrained by both total traveling length and road conditions.

The method 100 continues to in step 106 to initialize one or more searching parameters for one or more searching groups. Step 106 sets a searching direction for searching groups of the two searching categories. The searching parameters include the steps of defining a predetermined number of cooperating agents in each of two searching categories, namely, a forward searching category and a reverse searching category.

Path searching for the forward searching category begins from the start node 84a in FIG. 6. The forward searching category comprises the forward guided searching group and the forward free searching group described in paragraph

The number of cooperating agents in the forward searching category is denoted as M_{F}. The number of cooperating agents in the forward guided searching group is denoted as M_{Fg}. The number of cooperating agents in the forward free searching group is denoted as M_{Ff}. Hence, M_{F} combines both M_{Fg} and M_{Ff}. In other words, M_{F}=M_{Fg}+M_{Ff}.

The reverse searching category begins path searching from the destination node 84b in FIG. 6. The reverse searching category comprises the reverse guided searching group and the reverse free searching group. The number of cooperating agents in the reverse searching category is denoted as M_{R}. The number of cooperating agents in the reverse guided searching group is denoted as M_{Rg}. The number of cooperating agents in the reverse free searching group is denoted as M_{Rf}. Hence, M_{R} combines both M_{Rg} and M_{Rf}. In other words, M_{R}=M_{Rg}+M_{Rf}.

M, the total number of cooperating agents from the two searching categories is therefore: M=M_{F}+M_{R}. At this point of time, the path searching system 10 also defines path_{Gbest} (g) and N_{bstop} (g) as searching parameters, where path_{Gbest} (g) is used to store a best path searched by Group_{g}; while N_{bstop} (g) is used to stop a path searching cycling if the path searched by Group_{g} does not improve after N_{bstop} (g) cycles. Another searching parameter, NCₘₐₓ, which is the maximum number of cooperating agent search cycles repeated, is also initialized.

The path searching system 10 then proceeds to perform path searching cycles in step 108 on the source graph for a selected searching group to determine a best path for the selected searching group. After the best path is determined from step 108, the method 100 proceeds to store in step 110 the best path as path_{Gbest} (g) and a group counter g is incremented by one. The path searching cycles is then repeated for the remaining searching groups of the four searching groups. Each searching group, Group_{g} (g=1 to 4), generates one or more paths for storage in step 110.

In FIG. 7, step 112 determines if there are more searching groups that have not completed step 108 of the path searching cycles. With a ‘YES’, method 100 resumes step 108 and with a ‘NO’, the method 100 compares in step 114 the best path from each of the four searching groups to determine an optimal path. Following step 114, the method 100 continues to provide in step 116 the optimal path from the output of step 114. The method 100 ends in step 118 with the optimal path.

It is to be noted that the path optimizer 18 in FIG. 1 is applied because path solutions generated by multiple groups of cooperating agents may not be identical even though such path solutions may be similar. For a relatively simple source graph, the path optimizer 18 in FIG. 1 compares best paths from the searching groups to select the best one as the optimal path solution. For a complex source graph, the path optimizer 18 needs to break down each of the best paths, path_{Gbest}(g) where g=1 to 4, into small segments between nodes, Thereafter, Genetic Algorithms (GA) is used to optimize the best paths by selecting appropriate path segments to construct the optimal path according to predefined optimization criteria.

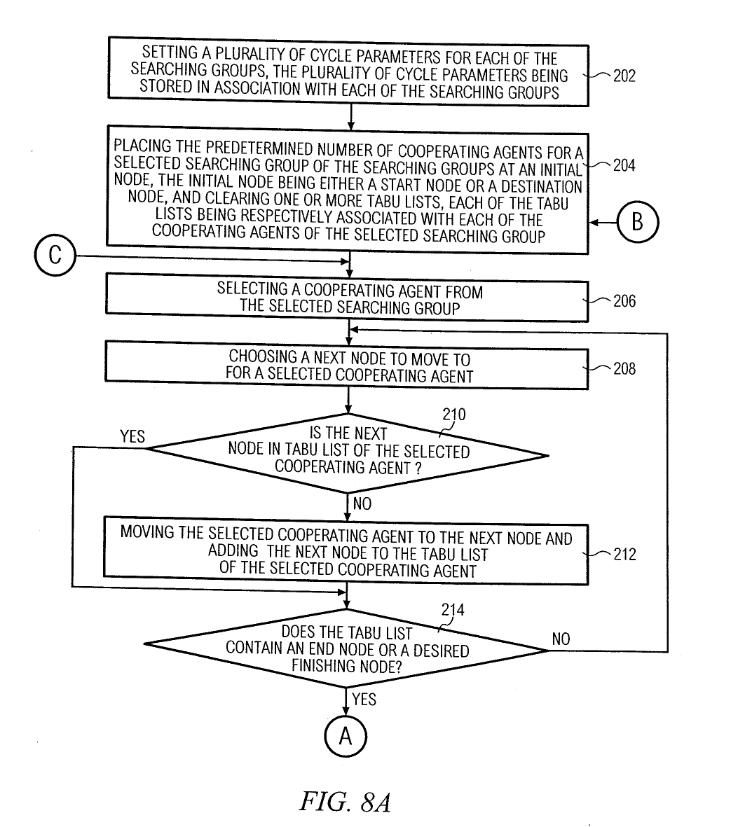

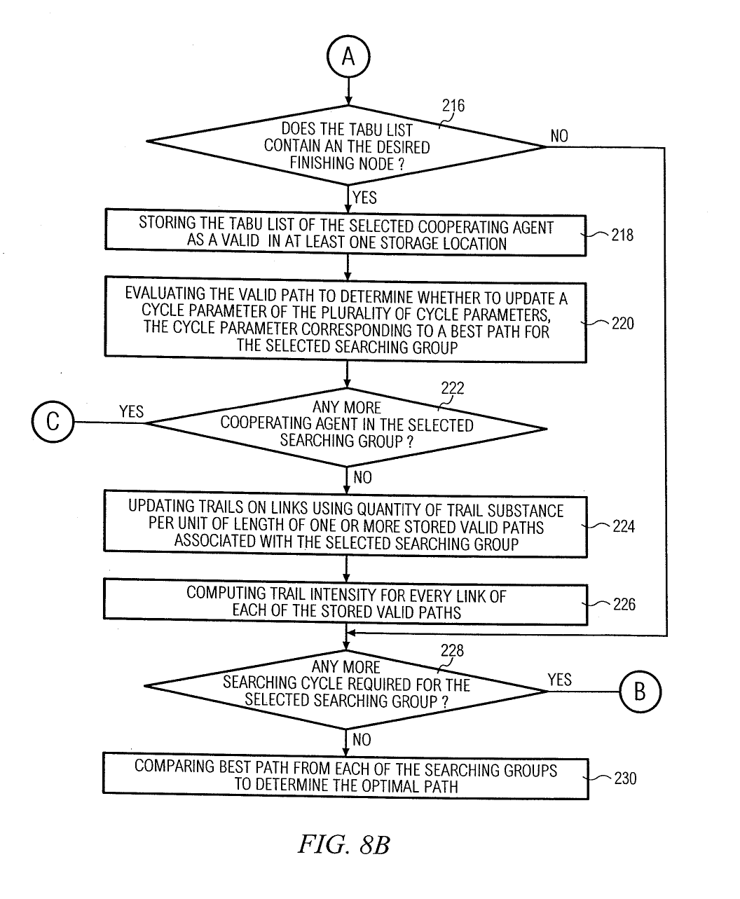

Referring now to FIGS. 8A and 8B, a flowchart illustrates details of path searching cycle module 108 in the method 100. Step 108 starts with initializing step 202 by setting a plurality of cycle parameters for each of the searching groups. The plurality of cycle parameters is stored in the storage medium 16 in FIG. 1 in association with each of the searching groups.

Initializing step 202 includes initializing a time counter t=0 and a cycle counter NC=0. Step 108 is repeated for each of the four searching groups Group_{g} (g=1 to 4). The path searching cycles module 108 proceeds in step 204 to place predetermined number of cooperating agents (m_{g}) for a selected searching group at an initial node. Depending on the searching direction, the initial node is either the start node or the destination node.

Step 204 clears one or more tabu lists and enters the initial node into each of the tabu lists. Each of the tabu lists is respectively associated with each of the cooperating agents of the selected searching group. Also, path_{best} and path_{Gbest} (g) are defined. The path_{best} is defined for storing a local best path searched in a current path searching cycle. The path_{Gbest} (g) is defined for storing a globally best path searched by the selected searching group from all path searching cycles. For every node i and for every link related to the node i, the path searching system 10 sets τ_{i,j}=c and Δτ_{i,j}=0, where c=0.01.

Again in FIG. 8A, a path searching cycle starts with selecting in step 206 a cooperating agent from the selected searching group. Thereafter, the path searching cycle module 108 continues with choosing in step 208 a next node to move to for a selected cooperating agent. Step 208 is based on the probability function, p^{k}_{i,j} of Equation (1).

Upon choosing in step 208 the next node, the path searching cycle module 108 determines in step 210 whether the next node is in a tabu list associated with the selected cooperating agent. With a “NO” when the next node is not already in the tabu list, the path searching cycle module 108 proceeds to move in step 212 the selected cooperating agent to the next node and add the next node to the tabu list. Thereafter, the path searching cycle module 108 determines in step 214 if the tabu list of the selected cooperating agent reaches an end node or a desired finishing node. With a “NO” the path searching cycle module 108 returns to step 208. Otherwise, with a “YES”, the path searching cycle module 108 continues to check in step 216 whether the tabu list contains the desired finishing node.

In checking step 216 in FIG. 8B whether the tabu list contains the desired finishing node, the path searching cycle module 108 determines whether the tabu list provides a valid path for the selected cooperating agent. The desired finishing node corresponds to either the start node or the destination node depending on the searching direction of the selected cooperating agent. In other words, if the selected cooperating agent is from a forward searching group, then desired finishing node is the destination node. Otherwise, for a reverse searching group, then the desired finishing node is the start node.

For a “YES” in step 216, the path searching cycle module 108 continues in step 218 to store the tabu list of the selected cooperating agent as a valid path in at least one storage location. The path searching cycle module 108 then proceeds to evaluating in step 220 the valid path to determine whether to update a cycle parameter of the plurality of cycle parameters. The cycle parameter that is updated corresponds to the best path, path_{best}, for the selected searching group.

In step 220, if pathₖ is better than the best path searched in this cycle (counter=NC) and denoted path^{NC}_{best} then the path searching cycle module 108 updates path^{NC}_{best} by assigning pathₖ to path^{NC}_{best}. The path searching cycle module 108 also compares path^{NC}_{best} with the global best path path_{Gbest}(g) searched so far and updates path_{Gbest}(g) with path^{NC}_{best} if path^{NC}_{best} is better than path_{Gbest}(g). In this situation, a counter (Nₙᵢ) for path searching cycles in which there is path improvement is intialised by setting Nₙᵢ=0. Otherwise, the counter Nₙᵢ is incremented by one to denote one path searching cycle has been performed with no path improvement.

Referring again to FIG. 8B, and after step 220, the path searching cycle module 108 continues to check in step 222 whether the selected searching group has another cooperating agent for steps 206, 208, 210 and 212. For a “YES” in response to step 222, the path searching cycle module 108 returns to step 206 to repeat steps 206, 208 and 210 for remaining cooperating agents of the selected searching group. In other words, the path searching cycle is repeated m_{g} times, where m_{g} is the total number of cooperating agents in the selected searching group. It is to be noted that if the selected cooperating agent reaches an end node that is not the desired finishing node, the next node would be in the tabu list and step 214 would therefore be a “YES” but step 216 would be a “NO”.

For a “NO” output from step 222, the path searching cycle module 108 continues in step 224 to update trails on links using quantity of trail substance per unit of length of one or more stored valid paths. Thereafter, step 226 computes trail intensity for every link of each of the stored valid paths and the trail intensity is initialized to zero (0) for a next path searching cycle.

The path searching cycle module 108 continues to determining in step 228 whether any more searching cycle is required for the selected searching group. For a “YES”, the path searching cycle module 108 returns to step 204. Otherwise, if either the best path has no improvement after N_{Bstop} cycles such as when Nₙᵢ>=N_{Bstop} or if the total number of path searching cycles reaches NCₘₐₓ (when NC>=NCₘₐₓ), then the path searching cycle module 108 stops with a “No” in step 228.

The path searching cycle module 108 then proceeds to comparing in step 230 the best path from each of the searching groups to determine the optimal path. As there are four searching groups, the best path from the four searching groups is compared in step 230 to select the optimal path.

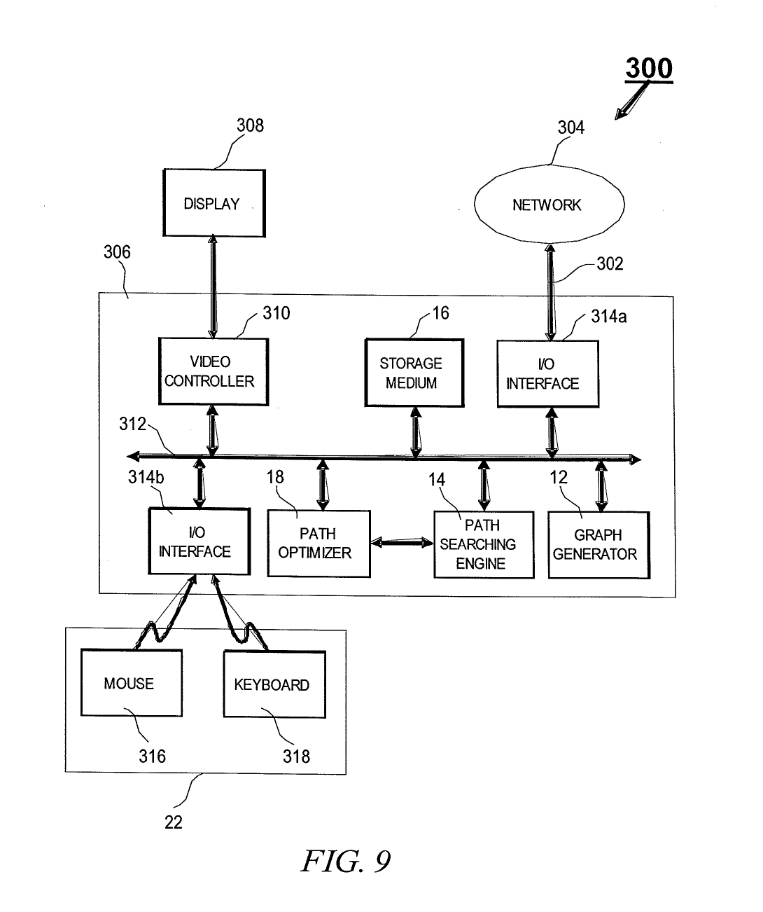

The method 100 can be executed via a computer program that is recorded on computer usable medium. Such computer usable medium may include random access memories (RAMs), read-only memories (ROMs), hard disks, and different types of compact discs or floppy disks. A product that comprises the computer program recorded on computer usable medium can be executed with, for example, a computer system 300 as illustrated in FIG. 9.

The computer system 300 can be, for example, a server when the path searching system 10 is implemented as a client-server system with different access rights for different users. As a server, the computer system 300 can be coupled via a communication resource 302 to a network 304 such as, for example, an Intranet or the Internet. The computer system 300 comprises a computer 306 that includes the storage medium 16 and the path searching engine 14. Typically, the computer 306 has, for example, an intelligent data processor that supports the functions of the path searching engine 14. The storage medium 16 can serve as the computer usable medium with the computer program recorded thereon. In this case, the storage medium 16 can be one or more memory devices such as random access memories (RAMs), read-only memories (ROMs), or hard disks. Alternatively, the storage medium 16 can be a memory device reader such as, for example, a compact disc drive or a floppy disk drive. Such a memory device reader enables access to the computer program by the path searching engine 14.

The display 308 is coupled to the path searching engine 14 via a video controller 310. Data flow within the computer 306 is by means of a data bus 312 that couples the video controller 310, the graph generator 12, the path searching engine 14, the storage medium 16, and an input/output (I/O) interface 314. The user input interface 22, comprising a mouse 316 and a keyboard 318, couples to the data bus 312 via another I/O interface 320.

The present invention therefore provides the path searching system 10, the method 100, and the product that comprises the computer program for executing the method 100 by the path searching system 10 to overcome, or at least alleviate, the problems of the prior art.

It will be appreciated that although one preferred embodiment has been described in detail, various modifications and improvements may be made by persons skilled in the art without departing from the scope of the present invention.

1. A path searching system based on ant colony optimization (ACO), said path searching system comprising:
at least one storage medium; and
a path searching engine, coupled to said at least one storage medium, wherein said path searching engine being adapted to perform road path searching cycles on a road map represented by a source graph to thereby determine an optimal road path between a start node and a destination node on the road map, wherein said source graph having a plurality of node links and a plurality of nodes including said start node and said destination node, wherein said plurality of nodes being interconnected each other via said plurality of node links to form a network, wherein said path searching cycles are carried out by multiple groups of cooperating agents based upon an improved ACO based map searching heuristic.

2. The path searching system of claim 1, and further comprising a graph constructor, coupled to said at least one storage medium, for constructing said source graph based on information associated with said plurality of nodes and said plurality of node links, said information being stored in said storage medium.

3. The path searching system of claim 2, further comprising an editor for editing said information, said information including constraints associated with said plurality of nodes and said plurality of node links.

4. The path searching system of claim 1, further comprising a search definer for defining one or more criteria for road paths derived from said path searching cycles.

5. The path searching system of claim 1, said improved ACO based map searching heuristic comprises a global visibility factor in addition to a trail intensity factor and local search desirability factor included in existing ant systems designed for traveling salesmen problem (TSP)

6. The path searching system of claim 5, wherein said global visibility factor is based on distance between a selected linked node and the end node to guide the searching agents, wherein the next node should generally be closer to the start node rather than further away.

7. The path searching system of claim 5, wherein said multiple groups of cooperating agents comprise guided cooperating agents and free cooperating agents, said guided cooperating agents being guided by said global visibility factor; said free cooperating agents not being guided by said global visibility factor.

8. The path searching system of claim 5, wherein said path searching engine is further adapted to determine said path in each of both a forward direction from said start node to said destination node and a reverse direction from said destination node to said start node.

9. The path searching system of claim 8, wherein said path searching engine is further adapted to provide at least two searching groups of cooperating agents for searching in said forward direction.

10. The path searching system of claim 8, wherein said path searching engine is further adapted to provide at least two searching groups of cooperating agents for searching in said reverse direction.

11. The path searching system of claim 8, wherein said path searching engine is further adapted to determine an optimal path from searching in said forward direction and said reverse direction.

12. A method of path searching based on ant colony optimization, said method comprising:
constructing a source graph having a plurality of nodes, each of said plurality of nodes having at least one link to another node of said plurality of nodes;
initializing one or more searching parameters for one or more searching groups;
and
performing path searching cycles on said source graph for each of said one or more searching groups to determine an optimal path.

13. The method of claim 12, wherein said constructing comprises:
retrieving data associated with said plurality of nodes;
and
identifying a start node and a destination node.

14. The method of claim 13, wherein said initializing comprises defining a predetermined number of cooperating agents for each of said searching groups.

15. The method of claim 14, wherein said initializing further comprises setting a searching direction for each of said searching groups.

16. The method of claim 15, wherein said performing comprises setting a plurality of cycle parameters for each of said searching groups, said plurality of cycle parameters being stored in association with each of said searching groups.

17. The method of claim 15, wherein said performing further comprises placing said predetermined number of cooperating agents for a selected searching group at an initial node, said initial node being either said start node or said destination node.

18. The method of claim 17, wherein said placing comprises:
clearing one or more tabu lists, each of said tabu lists being respectively associated with each of said cooperating agents of said selected searching group;
and
entering said initial node into each of said tabu lists.

19. The method of claim 18, wherein said performing further comprises:
selecting a cooperating agent from said selected searching group;
choosing a next node for a selected cooperating agent based on a probability function;
determining whether said next node is in a tabu list associated with said selected cooperating agent;
and
repeating said selecting, said choosing and said determining for remaining cooperating agents of said selected searching group.

20. The method of claim 19, wherein said repeating comprises adding said next node to said tabu list when not already in said tabu list.

21. The method of claim 20, wherein said repeating further comprises checking whether said tabu list provides a valid path when said next node is said finishing node.

22. The method of claim 21, wherein said performing further comprises storing said valid path when said tabu list provides said valid path.

23. The method of claim 22, wherein said performing further comprises evaluating said valid path to determine whether to update a cycle parameter of said plurality of cycle parameters, said cycle parameter corresponding to a best path for said selected searching group.

24. The method of claim 23, and further comprising checking whether said selected searching group has another cooperating agent for said selecting, said choosing, said determining and said repeating.

25. The method of claim 24, and further comprising updating trails on links using quantity of trail substance per unit of length of one or more stored valid paths.

26. The method of claim 25, and further comprising computing trail intensity for every link of each of said stored valid paths.

27. The method of claim 26, and further comprising comparing said best path from each of said one or more searching groups to determine said optimal path.

28. A product comprising computer usable medium having a computer program recorded thereon for road path searching based on ant colony optimization, said product comprising:
computer program code means for constructing a source graph; wherein said source graph having a plurality of node links and a plurality of nodes including said start node and said destination node, wherein said plurality of nodes being interconnected each other via said plurality of node links to form a network;
computer program code means for initializing one or more searching parameters for one or more searching groups;
and
computer program code means for performing path searching cycles on said source graph for each of said one or more searching groups to determine an optimal road path; wherein said path searching cycles are carried out by multiple groups of cooperating agents based upon an improved ACO based map searching heuristic.

29. The product of claim 28, wherein said computer program code means for constructing comprises:
computer program code means for retrieving data associated with said plurality of nodes;
and
computer program code means for identifying a start node and a destination node.

30. The product of claim 29, wherein said computer program code means for initializing comprises computer program code means for defining a predetermined number of cooperating agents for each of said searching groups.

31. The product of claim 30, wherein said computer program code means for initializing further comprises computer program code means for setting a searching direction for each of said searching groups.

32. The product of claim 31, wherein said computer program code means for performing comprises computer program code means for setting a plurality of cycle parameters for each of said searching groups, said plurality of cycle parameters being stored in association with each of said searching groups.

33. The product of claim 32, wherein said computer program code means for performing further comprises computer program code means for placing said predetermined number of cooperating agents for a selected searching group at an initial node, said initial node being either said start node or said destination node.

34. The product of claim 33, wherein said computer program code means for placing comprises:
computer program code means for clearing one or more tabu lists, each of said tabu lists being respectively associated with each of said cooperating agents of said selected searching group;
and
computer program code means for entering said initial node into each of said tabu lists.

35. The product of claim 34, wherein said computer program code means for performing further comprises:
computer program code means for selecting a cooperating agent from said selected searching group;
computer program code means for choosing a next node for a selected cooperating agent based on a probability function;
computer program code means for determining whether said next node is in a tabu list associated with said selected cooperating agent;
and
computer program code means for repeating said selecting, said choosing and said determining for remaining cooperating agents of said selected searching group.

36. The product of claim 35, wherein said computer program code means for repeating comprises computer program code means for adding said next node to said tabu list when not already in said tabu list.

37. The product of claim 36, wherein said computer program code means for repeating further comprises computer program code means for checking whether said tabu list provides a valid path when said next node is said finishing node.

38. The product of claim 37, wherein said computer program code means for performing further comprises computer program code means for storing said valid path when said tabu list provides said valid path.

39. The product of claim 38, wherein said computer program code means for performing further comprises computer program code means for evaluating said valid path to determine whether to update a cycle parameter of said plurality of cycle parameters, said cycle parameter corresponding to a best path for said selected searching group.

40. The product of claim 39, and further comprising computer program code means for checking whether said selected searching group has another cooperating agent for said selecting, said choosing, said determining and said repeating.

41. The product of claim 40, and further comprising computer program code means for updating trails on links using quantity of trail substance per unit of length of one or more stored valid road paths.

42. The product of claim 41, and further comprising computer program code means for computing trail intensity for every link of each of said stored valid road paths.

43. The product of claim 42, and further comprising computer program code means for comparing said best road path from each of said one or more searching groups to determine said optimal path.
